(19) United States
(12) Patent Application Publication
(10) Pub. No.: US 2003/0206191 A1
(43) Pub. Date: Nov. 6, 2003

(54) Browser-based scorm reader

(76) Inventors: Chad A. Schoettger, Louisville, CO (US); Jason A. Heddings, Erie, CO (US); Frank L. Well, Boulder, CO (US)

Correspondence Address: BLAKELY, SOKOLOFF, TAYLOR & ZAFMAN LLP, Seventh Floor, 12400 Wilshire Boulevard, Los Angeles, CA, 90025-1030, US

(21) Appl. No.: 10/138,230

(22) Filed: May 1, 2002

(51) Int. Cl. G09G 5/00

(52) U.S. Cl. 345/730; 345/749

(57) ABSTRACT

Disclosed are novel methods and apparatus for efficiently providing a SCORM reader and/or progress tracker. In an embodiment, a method of displaying courseware is disclosed. The method includes: providing a content database, a course structure database, a course progress database, and a delivery component. The content database may include content data corresponding to the courseware. The course structure database may include structure data corresponding to a structure of the courseware. The course progress database may include progress data corresponding to a progress of a user through the courseware. The delivery component may display the courseware. In addition, the delivery component may communicate with the content database, the course structure database, and the course progress database to display the courseware and track the progress of the user through the courseware. In another embodiment, the method may perform its tasks without requiring direct access to an LMS.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright© 2002, Sun Microsystems, Inc., All Rights Reserved.

### FIELD OF INVENTION

The present invention generally relates to the field of browser-based data readers. More specifically, an embodiment of the present invention provides a standalone, efficient sharable content object reference model (SCORM) reader and progress tracker for use in, for example, courseware applications.

### BACKGROUND OF INVENTION

As the number of computers increases worldwide, so does their use in educational settings. Many classrooms and libraries now provide access to data that may be located halfway around the world. Instead of a student having to be physically present in a class, the student may now attend a class by utilizing a computer thousands of miles away. In addition, training materials can be stored on computers (i.e., digitized) for use at a later time or while mobile.

Computer-based training materials are, however, largely developed on a proprietary (e.g., company-by-company) basis, resulting in high development costs and limited resale value. American companies alone spend billions of dollars a year on the development of training products with little of the investment focused on resale or external product development. To obviate these problem, the advanced distributive learning (ADL) initiative has been developing guidelines to create new markets for training materials, reduce the costs of development, and increase the potential return on investment. Further information regarding ADL may be found by reference to www.adlnet.org.

One common way to share educational information is to utilize a learning management system (LMS). An LMS generally includes solutions for cataloging, course registration, provision of a course, tracking (for example, by managers), and accounting. Such an LMS is typically a large software system, which can easily cost over $100,000. In most cases, an LMS is too costly for one user or cannot be run locally on a client's system, which may lack the necessary local resources. Moreover, network access to an LMS often requires a relatively fast network connection capable of shuttling the comprehensive amount of data involved. As such, a remote user (e.g., with only a 56 kbps modem) will have a hard time accessing an LMS.

One solution for sharing courseware amongst LMS providers is to use SCORM, which is developed by the ADL. SCORM provides a reference model that defines a Web-based learning content model. Moreover, SCORM provides a set of interrelated technical specifications designed to meet the Department of Defense's high-level requirements. SCORM, however, requires that a SCORM-compliant course be viewed through an LMS. More specifically, SCORM requires that the LMS have the ability to determine what to deliver and when, and track the student's progress through the learning content. Accordingly, students and course authors who lack access to an LMS (e.g., directly or through a computer network) are unable to view or take SCORM-compliant courses.

### SUMMARY OF INVENTION

The present invention, which may be implemented utilizing a general-purpose digital computer, in certain embodiments, includes novel methods and apparatus to provide efficient, lightweight, and/or standalone SCORM readers and/or progress trackers. In an embodiment, a method of displaying courseware is disclosed. The method includes: providing a content database, a course structure database, a course progress database, and a delivery component. The content database may include content data corresponding to the courseware. The course structure database may include structure data corresponding to a structure of the courseware. The course progress database may include progress data corresponding to a progress of a user through the courseware. The delivery component may display the courseware. In addition, the delivery component may communicate with the content database, the course structure database, and the course progress database to display the courseware and track the progress of the user through the courseware. In another embodiment, the method may perform its tasks without requiring direct access to an LMS.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which the present invention may be embodied;

FIG. 2 illustrates an exemplary block diagram of a system 200 in accordance with an embodiment of the present invention;

FIG. 3 illustrates an exemplary object model 300 in accordance with an embodiment of the present invention;

FIG. 4 illustrates an exemplary user interface 400 in accordance with an embodiment of the present invention; and

FIG. 5 illustrates an exemplarily window 500 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment” or “an embodiment” means that a particular feature, structure, or characteristic described in connection with the embodiment is included in at least an embodiment of the invention. The appearances of the phrase “in one embodiment” in various places in the specification are not necessarily all referring to the same embodiment.

In addition, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, optical disks, compact disc-read only memories (CD-ROMs), and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

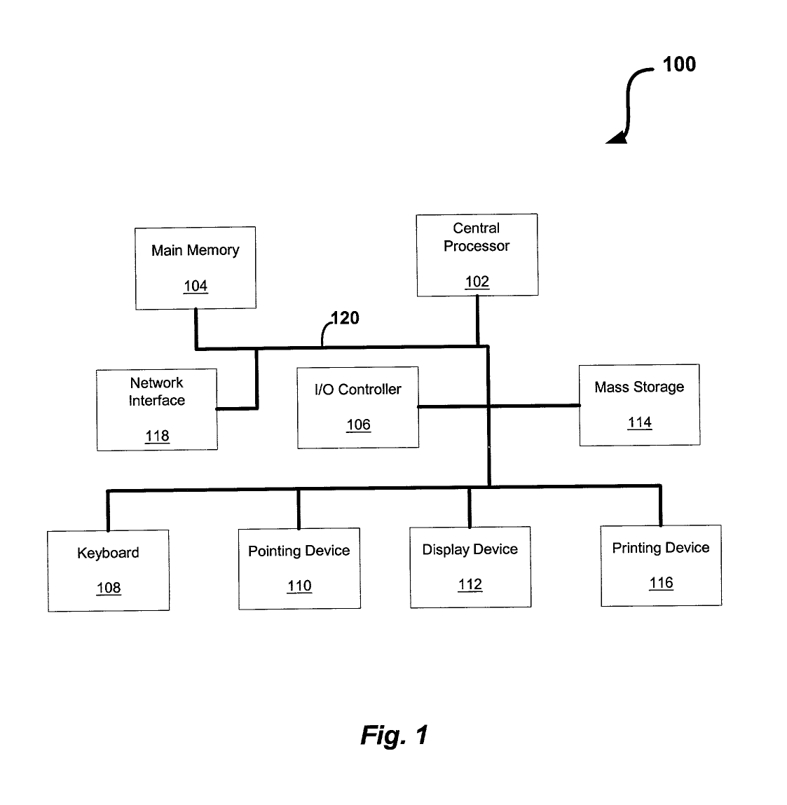

FIG. 1 illustrates an exemplary computer system 100 in which the present invention may be embodied in certain embodiments. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In an embodiment, the computer system 100 includes a Sun Microsystems computer utilizing a SPARC microprocessor available from several vendors (including Sun Microsystems of Palo Alto, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). In addition, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments, the network interface 118 can be implemented utilizing technologies including, but not limited to, Ethernet, Fast Ethernet, wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments, the computer system 100 is a general purpose computer capable of running any number of applications such as those available from companies including Oracle, Siebel, Unisys, Microsoft, and the like.

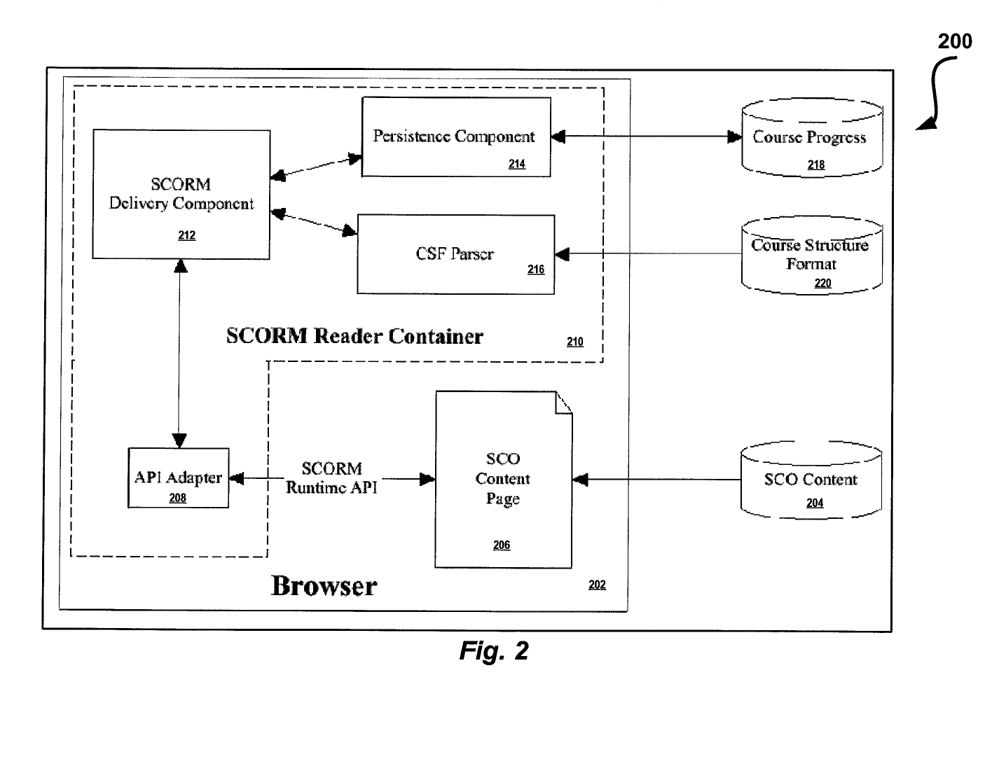

FIG. 2 illustrates an exemplary block diagram of a system 200 in accordance with an embodiment of the present invention. In one embodiment, the arrows in FIG. 2 indicate the direction of information flow. It is, however, envisioned that the information may flow in various directions, for example, depending on the specific implementation, with the attainment of all or some of the advantages. The system 200 includes a browser 202 which may have access to a sharable content object (SCO) content database 204. Generally, a database as used herein is envisioned to include any collection of data that is organized for collection and/or retrieval. A SCO generally represents a collection of one or more assets that include a specific launchable asset that utilizes the SCORM runtime environment to communicate with an LMS. More specifically, a SCO represents the lowest level of granularity of learning resources that can be tracked by an LMS using the SCORM runtime environment. The SCORM standard is hereby incorporated herein by reference for all purposes. Further information regarding the SCORM standard may be found by reference to www.adlnet.org.

In an embodiment, the browser 202 may be selected from any available browsers such as the Internet Explorer available from Microsoft Corporation of Redmond, Wash., and the Netscape Navigator available from various sources including iPlanet, now a division of Sun Microsystems, Inc., of Palo Alto, Calif. The browser 202 includes a SCO content page 206 which can display content obtained, for example, from the SCO content database 204. The browser 202 further includes an application programming interface (API) adapter 208 which may receive SCORM compliant information and/or requests (e.g., through a SCORM runtime API) from the SCO content page 206. The requests may include initialize and finish requests, for example, signifying the start and end of that SCO's content delivery. The requests may also include get and/or set requests for the specific data defined in the SCORM runtime data model, for example.

The browser 202 may additionally include a SCORM reader container 210, which is capable of communicating with the API adapter 208. In an embodiment, the SCORM reader container 210 may be implemented as an applet or a signed applet. A signed applet will be beneficial when, for example, a mechanism is required to read and/or write to a user's hard drive. Generally, applets are not allowed to read/write from a local disk, unless the respective applet is either signed or its code is located in the browser's class path, for example. The SCORM reader container 210 includes a SCORM delivery component 212 which may receive information from the API adapter 208. In one embodiment, the API adapter 208 is envisioned to perform appropriate formatting and/or translation of information communicated between the SCORM runtime API and an LMS. The SCORM reader container 210 further includes a persistence component 214 and a course structure format (CSF) parser 216. The SCORM delivery component 212 may communicate with the persistence component 212 and the CSF parser 216. The system 200 further includes a course progress database 218 which can be accessed by the persistence component 214. The system 200 also includes a CSF database 220 which may provide information to the CSF parser 216 regarding, for example, the course structure and/or content. In an embodiment, the CSF components are implemented in accordance with the SCORM standard.

In one embodiment, the SCORM reader container 210 may be implemented in Java or other appropriate programming environments. In one embodiment, the API adapter 208 may include seven methods as defined by the ADL. The persistent component 214 may store data temporarily until the user has access to, for example, an LMS System. In one embodiment, the persistent component saves its data to a non-volatile memory (such as the mass storage 114 of FIG. 1) when exiting SCO content. In a further embodiment, the persistent component saves its data directly to a non-volatile memory (such as the mass storage 114 of FIG. 1). The course progress database 218 may store data indicating SCORM information that a user has already viewed, the user's exit status, and/or a SCO's status on exit. This is, for example, very helpful to bring a user back to where that user had previously left off. Therefore, an embodiment of the present invention will capture and persist all of the mandatory data defined in the SCORM runtime data model for future synchronization with, for example, an LMS.

Accordingly, an embodiment of the present invention provides the SCORM delivery component 212, which displays courseware in a browser window in accordance with the SCORM standard. The courseware may include tests and/or general teaching data. The SCORM delivery component 212 may receive requests from the SCO content page 206 (through, for example, the API adapter 208) and obtain appropriate SCORM-based information from the CSF database 220 (through, for example, the CSF parser 216). The SCORM delivery component 212 may store information regarding the user's progress in the course progress database 218 (for example, through the persistence component 214) for future reference.

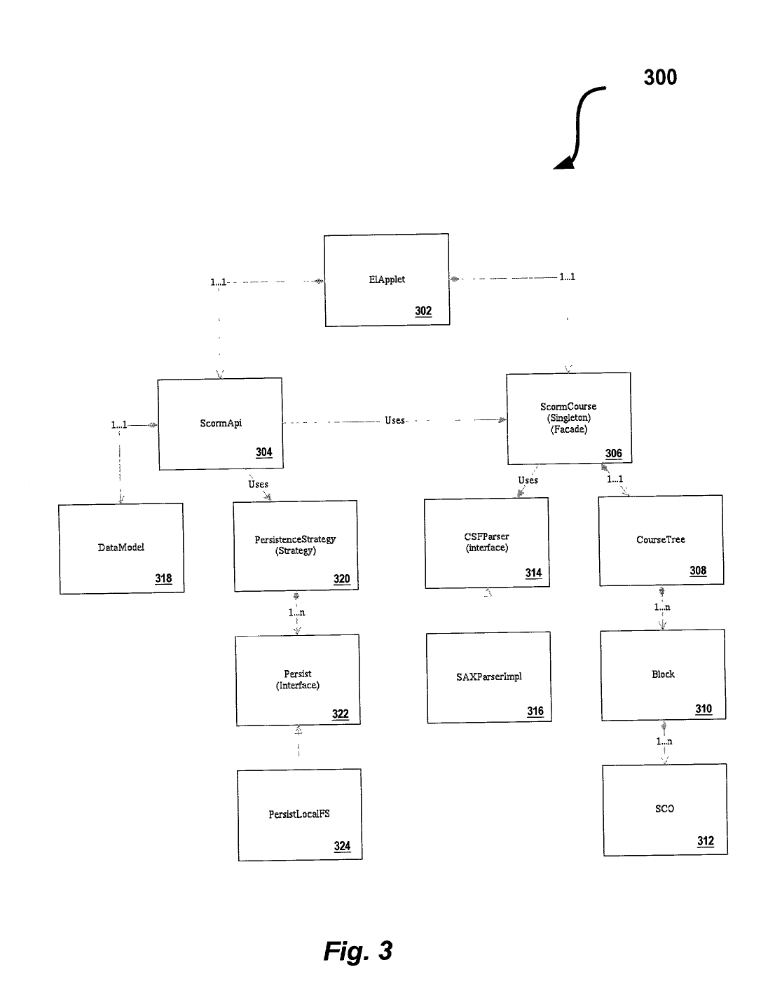

FIG. 3 illustrates an exemplary object model 300 in accordance with an embodiment of the present invention. The object model 300 includes an applet 302, which supports interfaces to a SCORM API 304 and a SCORM course class 306. In an embodiment, SCORM API 304 may be implemented for the API adapter 208. The SCORM course class 306 will provide navigation and access support to SCORM content such as those discussed with respect to FIG. 2. In one embodiment, Java script may be utilized to communicate data into the applet 302 from the SCORM API 304 and the SCORM course class 306. The SCORM course class 306 has access to a course tree 308, which in turn has access to a plurality of blocks 310. The blocks 310 may act as containers for SCOs 312. The SCORM course class 306 also has access to a CSF parser 314 which can parse CSF type files for the SCORM course class 306. In an embodiment, CSF parser 314 may be utilized for the CFS parser 216 of FIG. 2.

The CSF parser 314 may also have access to a different parser, if appropriate. For example, if the CSF content is in a format such as XML, a SAX parser 316 may be utilized to parse the XML content into a format suitable for the CSF parser 314. The SCORM API 304 further has access to a data model 318 which may be configured based on the arrangement of data utilized by the object model 300. The SCORM API 304 also has access to a persistence strategy object 320 which in turn may have access to a set of persist interfaces 322. In an embodiment, the persistence strategy object 320 may be utilized for the persistence component 214 of FIG. 2. Each of the persist interfaces 322 may have access to a persist local file system 324. The persist local file system 324, in an embodiment, may be implemented utilizing the course progress database 218 of FIG. 2.

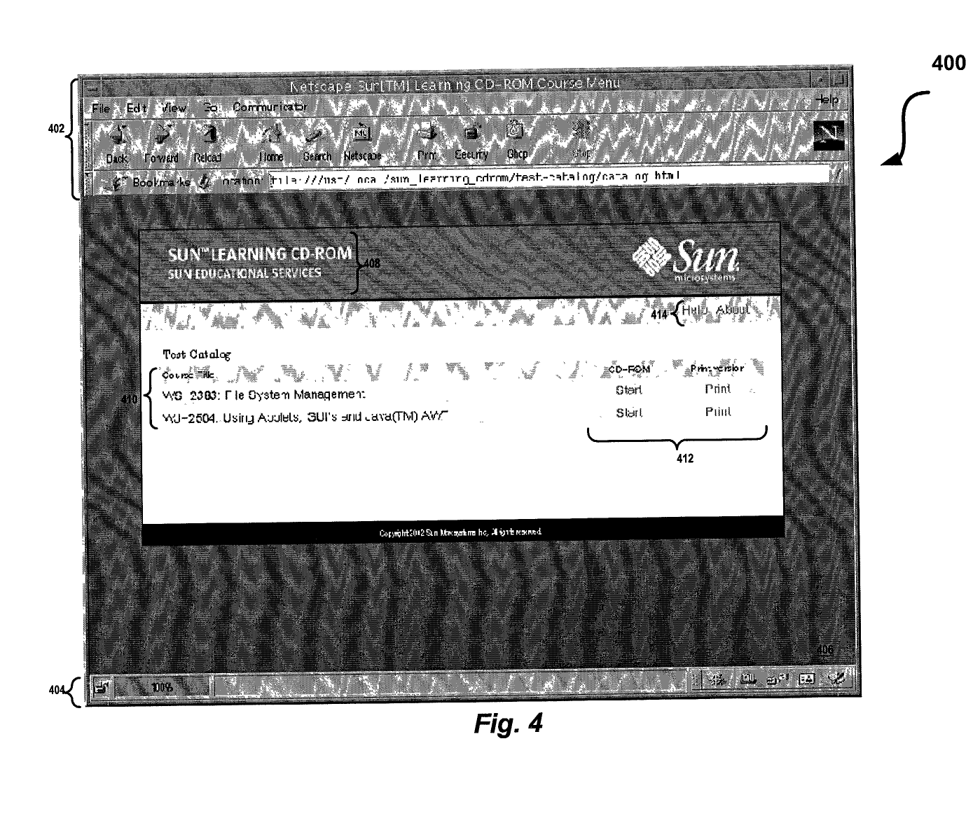

FIG. 4 illustrates an exemplary user interface 400 in accordance with an embodiment of the present invention. The interface 400 may include customary browser menus 402 and 404. The interface 400 includes a content window 406 which may display information to a user. The content window 406 may include information on title of a course being taken (408), course title information 410, and course versions 412. The content window 406 may also provide other information, including help and/or version information (414). In an embodiment, the interface 400 is shown to a user as a start up page. In another embodiment, the information displayed in the content window 406 may be provided by the system 200 of FIG. 2 and/or the object model 300 of FIG. 3.

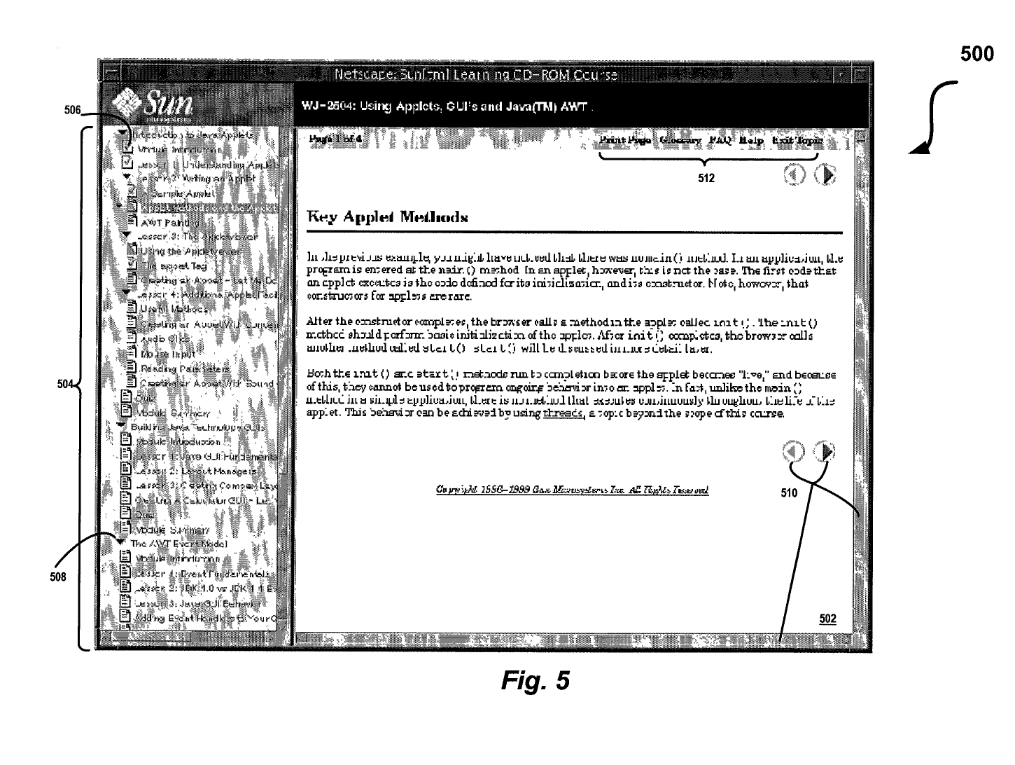

FIG. 5 illustrates an exemplarily window 500 in accordance with an embodiment of the present invention. The window 500 includes a content portion 502 and a tree portion 504. The tree portion 504 may, in turn, include hierarchical menus of subjects. It is envisioned that, in an embodiment, once a user views a selected subject, that subject is marked as having been viewed in the tree portion 504. The progress information may be illustrated by a special marking in the tree portion 504 such as a check mark 506. The tree portion 504 may further include interactive objects to view details about a given subject (508). The content window 502, in an embodiment, may be similar to the SCO 312 of FIG. 3 and/or the SCO content page 206 of FIG. 2, for example, in accordance with the SCORM standard. The content window 502 may further include navigational tools (510) and command buttons (512). In one embodiment, the information displayed in the window 500 may be provided by the system 200 of FIG. 2 and/or the object model 300 of FIG. 3.

Accordingly, in an embodiment, the present invention addresses issues associated with the prior art by providing a lightweight platform to display SCORM courseware which can be run in an author's or student's Web browser, for example, on a standalone computer system with no access to a network. The data stored on a computer locally may include the course progress database 218, the CSF database 220, and the SCO content database 204 of FIG. 2. In one embodiment, the present invention provides a lightweight implementation of all necessary APIs required by the SCORM courseware.

Moreover, the SCORM courseware may communicate directly with embodiments of the invention instead of an LMS. For example, an embodiment of the present invention can store runtime data supplied by the SCORM courseware and provide a course navigation user-interface, which enables students and/or authors to traverse the SCORM courseware.

Since in select embodiments no network connection is required, the present invention may be extremely suitable for users who are traveling (e.g., with a laptop) or are at remote locations (e.g., on an airplane) without access to a computer network. Additionally, course authors may benefit because they can develop SCORM-compliant courseware without having access to an LMS. For example, the authors may edit their courses on their local storage devices (such as their hard drive, flash memory, or CDRW drive) and review the edited course, as it would appear if delivered by an LMS.

The foregoing description has been directed to specific embodiments. It will be apparent to those with ordinary skill in the art that modifications may be made to the described embodiments, with the attainment of all or some of the advantages. For example, the techniques of the present invention may be applied to computer-based and/or electronic gaming technologies. In addition, instead of an applet, other solutions may be utilized including, but not limited to, a stand-alone application, an object, a program, a procedure, and the like. Therefore, it is the object of the appended claims to cover all such variations and modifications as come within the spirit and scope of the invention.

What is claimed is:

1. A method of displaying courseware, the method comprising:
providing a content database, the content database including content data corresponding to the courseware;
providing a course structure database, the course structure database including structure data corresponding to a structure of the courseware;
providing a course progress database, the course progress database including progress data corresponding to a progress of a user through the courseware; and
providing a delivery component to display the courseware, the delivery component communicating with the content database, the course structure database, and the course progress database to display the courseware and track the progress of the user through the courseware without requiring direct access to an LMS.

2. The method of claim 1 further including synchronizing at least one database selected from a group comprising the content database, the course structure database, and the course progress database with the LMS.

3. The method of claim 2 wherein the synchronization is performed after a direct access is established to the LMS.

4. The method of claim 2 wherein the synchronization is performed periodically.

5. The method of claim 1 wherein the direct access is established through a connection selected from a group comprising Ethernet, Fast Ethernet, WAN, leased line, OC3, DSL, cellular, TDM, ATM, satellite, analog modem, cable modem, USB, and FireWire.

6. The method of claim 1 further including providing a persistence component to facilitate communication between the delivery component and the course progress database.

7. The method of claim 1 further including providing a course structure format parser to facilitate communication between the delivery component and the course structure database.

8. The method of claim 1 further including providing a runtime API to facilitate communication between the delivery component and the content database.

9. The method of claim 8 wherein the runtime API is implemented in accordance with SCORM.

10. The method of claim 1 wherein the content database includes SCO content.

11. The method of claim 1 wherein the course structure database includes CSF data.

12. The method of claim 1 wherein the courseware is provided in accordance with SCORM.

13. The method of claim 1 wherein the courseware is displayed in a browser window.

14. The method of claim 13 wherein the browser is selected from a group comprising Internet Explorer and Netscape Navigator.

15. A system for provision of courseware, the system comprising:
a content database, the content database including content data corresponding to the courseware;
a course structure database, the course structure database including structure data corresponding to a structure of the courseware;
a course progress database, the course progress database including progress data corresponding to a progress of a user through the courseware; and
a delivery component to display the courseware, the delivery component communicating with the content database, the course structure database, and the course progress database to display the courseware and track the progress of the user through the courseware without requiring direct access to an LMS.

16. The system of claim 15 wherein the direct access is established through a connection selected from a group comprising Ethernet, Fast Ethernet, WAN, leased line, OC3, DSL, cellular, TDM, ATM, satellite, analog modem, cable modem, USB, and FireWire.

17. The system of claim 15 further including a persistence component to facilitate communication between the delivery component and the course progress database.

18. The system of claim 15 further including a course structure format parser to facilitate communication between the delivery component and the course structure database.

19. The system of claim 15 further including a runtime API to facilitate communication between the delivery component and the content database.

20. The system of claim 19 wherein the runtime API is implemented in accordance with SCORM.

21. The system of claim 15 wherein the content database includes SCO content.

22. The system of claim 15 wherein the course structure database includes CSF data.

23. The system of claim 15 wherein the courseware is provided in accordance with SCORM.

24. The system of claim 15 wherein the courseware is displayed in a browser window.

25. The system of claim 24 wherein the browser is selected from a group comprising Internet Explorer and Netscape Navigator.

26. A system for provision of courseware, the system comprising:
content means, the content means including content data corresponding to the courseware;
course structure means, the course structure means including structure data corresponding to a structure of the courseware;
course progress means, the course progress means including progress data corresponding to a progress of a user through the courseware; and
delivery component means for displaying the courseware, the delivery component communicating with the content means, the course structure means, and the course progress means to display the courseware and track the progress of the user through the courseware.

27. The system of claim 26 further including persistence means for facilitating communication between the delivery component means and the course progress means.

28. The system of claim 26 further including course structure format parsing means for facilitating communication between the delivery component means and the course structure means.

29. The system of claim 26 further including runtime API means for facilitating communication between the delivery component means and the content means.

30. An article of manufacture comprising:
a machine readable medium that provides instructions that, if executed by a machine, will cause the machine to perform operations including:
providing a content database, the content database including content data corresponding to a courseware;
providing a course structure database, the course structure database including structure data corresponding to a structure of the courseware;
providing a course progress database, the course progress database including progress data corresponding to a progress of a user through the courseware; and
providing a delivery component to display the courseware, the delivery component communicating with the content database, the course structure database, and the course progress database to display the courseware and track the progress of the user through the courseware without requiring direct access to an LMS.

31. The article of claim 30 wherein the operations further include synchronizing at least one database selected from a group comprising the content database, the course structure database, and the course progress database with the LMS.

32. The article of claim 30 wherein the operations further include providing a persistence component to facilitate communication between the delivery component and the course progress database.

33. The article of claim 30 wherein the operations further include providing a course structure format parser to facilitate communication between the delivery component and the course structure database.

34. The article of claim 30 wherein the operations further include providing a runtime API to facilitate communication between the delivery component and the content database.

35. The article of claim 34 wherein the runtime API is implemented in accordance with SCORM.
